(19) United States
(12) Patent Application Publication
(10) Pub. No.: US 2015/0307678 A1
(43) Pub. Date: Oct. 29, 2015

(54) PARTICLE REINFORCED CELLULAR FOAM AND PREPARATION METHOD THEREOF

(71) Applicant: INDUSTRIAL CORPORATION FOUNDATION CHONBUK NATIONAL UNIVERSITY, Jeonju-si (KR)

(72) Inventors: Seong Su KIM, Jeollabuk-do (KR); Dai Gil LEE, Daejeon (KR); Bu Gil KIM, Daejeon (KR); Seung A SONG, Jeollabuk-do (KR); Hyun Chul LEE, Jeollabuk-do (KR)

(73) Assignee: INDUSTRIAL CORPORATION FOUNDATION CHONBUK NATIONAL UNIVERSITY, Jeollabuk-do (KR)

(21) Appl. No.: 14/441,189

(22) PCT Filed: Mar. 27, 2013
(86) PCT No.: PCT/KR2013/002555

§ 371 Date: May 7, 2015

(30) Foreign Application Priority Data
Nov. 9, 2012 (KR) 10-2012-0127018

(51) Int. Cl. C08J 9/00; C08J 3/28

(52) U.S. Cl. CPC C08J 9/0066; C08J 3/28; C08J 2361/06

(57) ABSTRACT

Provided are a particle-reinforced cellular foam which has a uniform closed cell structure and exhibits markedly improved specific strength and thermal insulation performance, and a method for producing the particle-reinforced cellular foam.

### BACKGROUND OF THE INVENTION

1. Field of the Invention

The present invention relates to a particle-reinforced cellular foam and a method for producing the same.

2. Description of the Related Art

Commercially available polymer foams having low thermal conductivity characteristics are used as thermally insulating materials in a variety of applications such as construction decorations, automobiles, and liquefied natural gas (LNG) carrier vessels.

Polymer foams manufactured from polyurethane and polystyrene foam materials are representative thermally insulating materials that are commercially available, and these polymer foams have an advantage of having lower thermal conductivity and lower density compared with polymer foams manufactured from other materials. However, use of the polyurethane and polystyrene-based polymer foams has been restricted due to low flame retardancy and the generation of toxic gases at the time of combustion.

In order to solve these problems, research has been actively conducted in order to produce a thermally insulating foam using phenolic resins that have excellent flame retardancy and high flash points and produce less toxic gases at the time of combustion. However, despite such excellent heat resistance and reduced generation of toxic gases, the range of applications of conventional phenolic material-based expanded foams has been limited due to the time taken for expansion at the time of production and poor mechanical properties.

Furthermore, in connection with the production of phenolic material-based expanded foams, a molding method of expanding a phenolic resin in a short time by utilizing microwaves has been developed. However, this method has a disadvantage that a large amount of open cells are formed in the interior of the phenol foam, and it is difficult to control the cell wall thickness. Furthermore, since open cells have higher hygroscopic properties compared with closed cells, these open cells may make the foams sensitive to external environmental factors, and may act as a factor for the deterioration of mechanical properties.

### SUMMARY OF THE INVENTION

### Technical Problem

It is an object of the present invention to provide a particle-reinforced cellular foam having a reinforced expanded state and reinforced physical properties.

Another object of the present invention is to provide a method for producing the particle-reinforced cellular foam.

### Solutions to Problem

According to an aspect of the present invention, there is provided a method for producing a particle-reinforced cellular foam, the method including a step of producing an foaming composition containing a phenolic resin and bubble-adsorbing particles; and a step of adding a curing accelerator to the foaming composition, and then irradiating the foaming composition with microwaves within a time period of the curing start point (t_{cs})±10%.

The phenolic resin may be a resol-type phenolic resin.

The bubble-adsorbing particles may be particles having an average particle size of 37 μm (400 mesh) to 595 μm (30 mesh).

Preferably, the bubble-adsorbing particles may be particles of a material selected from the group consisting of activated carbon, activated alumina, zeolites, silica gel, molecular sieves, carbon black, and mixtures thereof.

The curing accelerator may be a substance selected from the group consisting of para-toluenesulfonic acid, xylenesulfonic acid, and a mixture thereof.

Preferably, the microwaves may be irradiated within a time period ranging from −5% to +5% of curing start point.

According to another aspect of the present invention, a particle-reinforced cellular foam produced by the production method described above is provided.

The particle-reinforced cellular foam has a closed cell structure.

Preferably, the particle-reinforced cellular foam has a cell diameter of 50 μm to 400 μm, and a density of 50 kg/m³ to 150 kg/m³.

According to another aspect of the present invention, there is provided a thermally insulating material containing the particle-reinforced cellular foam produced by the above-described production method.

Specific matters of the other embodiments of the present invention are illustrated in the detailed description of the invention given below.

### Advantageous Effects of Invention

According to the production method of the present invention, when micrometer-sized or nanometer-sized activated coal particles are added at the time of production of an expanded foam, the gas produced during the expansion process is adsorbed, and thereby, the enlargement of cells caused by gas bubbles and the production of open cells can be suppressed. As a result, a closed cell structure having cells with a uniform size can be formed.

Furthermore, according to the production method described above, a particle-reinforced cellular foam having specific strength and thermal insulation performance that are markedly improved as compared with cellular foams of the prior art, can be produced by controlling the initial degree of curing by means of a time difference before the microwave irradiation is conducted in the process of curing a phenolic resin, and thereby enhancing the thermal and mechanical properties of the cellular foam.

### BRIEF DESCRIPTION OF THE DRAWINGS

FIG. 1 is a graph showing the extinction coefficient of a cellular foam during the process of curing at normal temperature according to Example 1-1 in Test Example 1.

FIG. 2 is a photograph showing the results of an observation by scanning electron microscopy (SEM) of the particle-reinforced cellular foam produced in Example 1-2.

FIG. 3 is a photograph showing the results of an observation by SEM of the cellular foam produced in Comparative Example 1-2.

FIG. 4 is a graph showing the results of measuring the cell diameters in the cellular foams produced in Examples 1-1 to 1-3 and Comparative Examples 1-1 to 1-3.

FIG. 5 is a graph showing the results of measuring the densities of the cellular foams produced in Examples 1-1 to 1-3 and Comparative Examples 1-1 to 1-3.

FIG. 6 is a graph showing the thermal conductivities of the particle-reinforced cellular foams produced in Examples 1-1 to 1-3.

FIG. 7 is a graph showing the results of measuring the compressive strength of the particle-reinforced cellular foams produced in Examples 1-1 to 1-3.

FIG. 8 is a graph showing the results of measuring the specific strength of the particle-reinforced cellular foams produced in Examples 1-1 to 1-3.

### DETAILED DESCRIPTION OF THE PREFERRED EMBODIMENTS

Hereinafter, embodiments of the present invention are described in detail. However, these embodiments are only for illustrative purposes and are not intended to limit the present invention by any means. The present invention is to be defined by the scope of the claims described below.

At the time of producing an expanded foam by expansion molding, the viscosity of the resin contributes highly to the size and uniformity of the cells formed in the expanded foam.

In this regard, the present invention is characterized in that at the time of expansion molding a polymer resin using microwaves, when adsorbent particles that can increase the viscosity of the resin and can adsorb gases produced upon resin expansion are used, and the movement of gas bubbles generated at the time of expansion to enlarge themselves is controlled by applying an optimum initial degree of curing before the expansion caused by microwaves, the growth of cells is suppressed, thin and uniform cell walls are formed, consequently the cell density and the cell wall thickness are well controlled, and thus a particle-reinforced cellular foam having enhanced expandability and excellent mechanical characteristics is produced.

That is, the method for producing a particle-reinforced cellular foam according to an embodiment of the present invention includes a step of producing an foaming composition containing a phenolic resin and a bubble-adsorbing particles; and a step of adding a curing accelerator to the foaming composition, and then irradiating the foaming composition with microwaves within a time period of the curing start point±10%.

The respective steps will be explained in detail below.

Step 1 is a step of producing an foaming composition for forming the particle-reinforced cellular foam according to the present invention.

The foaming composition may be produced by mixing a phenolic resin and adsorbent particles.

Examples of the phenolic resin include novolac type phenolic resins and resol type phenolic resins. A phenolic resin undergoes curing by being sequentially subjected to stage A in which a low molecular weight oligomer is converted to a rubbery state and to stage B in which the glass transition temperature (Tg) of the reaction product is lower than the reaction temperature, and then non-melting or non-fusing solidification occurs, followed by stage C which is the final curing stage. A novolac type phenolic resin having thermoplastic properties does not have a reactive methylol group, and therefore, curing does not occur through heating only, but curing occurs by a heat treatment only after a crosslinking agent such as hexamethylenetetramine (HMTA) is added. On the other hand, in the case of a resol type phenol resin, curing occurs as a result of a heat treatment under reduced pressure and a heat treatment at normal pressure. Accordingly, in the present invention, it is preferable to use a resol type phenolic resin that can be cured by a heat treatment under reduced pressure and a heat treatment at normal pressure without the use of a curing agent.

The resol type phenolic resin can be produced in a liquid form of phenol added with formaldehyde, by adding an excess amount of formaldehyde to phenol, and then polycondensing the mixture under the conditions of the presence of an excess of formaldehyde at a ratio of phenol and formaldehyde of 1:1.5, in the presence of an alkali catalyst at a temperature in the range of 40° C. to 100° C.

Specific examples of the resol type phenolic resin include a phenol type resin, a cresol type resin, an alkyl type resin, a bisphenol A type resin, and copolymers thereof, and among these resins, one kind may be used alone, or a mixture of two or more kinds may be used.

In general, a resol-based phenolic resin is cured by a reaction represented by the following reaction scheme (1):

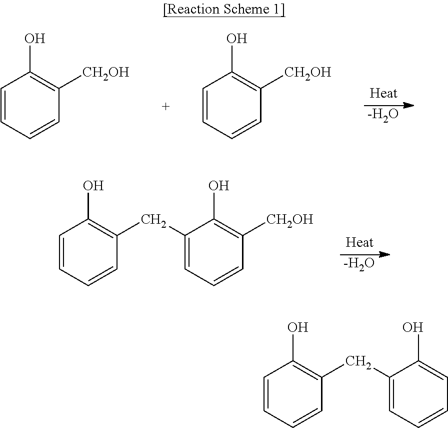 [SMILES: OCc1ccccc1O ; OCc1ccccc1O ; "-H2O" ; OCc1cccc(Cc2ccccc2O)c1O ; "-H2O" ; Oc1ccccc1Cc1ccccc1O]

As shown in the above Reaction Scheme 1, H₂O is generated in the process of curing a resol type phenolic resin, and H₂O is vaporized by the subsequent heating process intended for expansion after curing of the phenolic resin. Through this vaporization, fine gas bubbles are formed.

In the present invention, bubble-adsorbing particles are used so that the particles adsorb the H₂O gas bubbles produced in the processes of curing and expansion of the phenolic resin so as to suppress the formation of open cells that are generated as a result of cell growth. The bubble-adsorbing particles also plays the role of inducing a viscosity increasing effect in the foaming composition, and thereby inhibiting enlargement of the gas bubbles produced at the time of expansion.

When an expanded foam is produced by incorporating the bubble-adsorbing particles to an foaming composition, the H₂O gas bubbles generated in the process of curing of the phenolic resin are surrounded by the bubble-adsorbing particles due to the adsorbent properties of the bubble-adsorbing particles, and the H₂O gas bubbles are vaporized in the subsequent process of heat treatment for expansion. As a result, pores are formed by the bubble-adsorbing particles. Accordingly, pores having a size equivalent to the size of the H₂O gas bubbles are formed.

Accordingly, it is preferable that the bubble-adsorbing particles exhibit excellent gas bubble adsorbent properties owing to the large specific surface area, and to this end, it is preferable that the bubble-adsorbing particles have a size in the order of several hundred nanometers to several hundred micrometers. Specifically, the bubble-adsorbing particles may have an average particle size of 37 μm (30 mesh) to 595 μm (400 mesh), and in this case, 1 mesh means the number of grids included in a square network having an area of 25.4 mm in width and 25.4 mm in length.

Regarding the bubble-adsorbing particles, any particles can be used without any particular limitations as long as the particles have adsorption performance on the gases generated in the production process for an expanded foam. Specifically, activated carbon, activated alumina, zeolites, silica gel, molecular sieves, carbon black or the like can be used, and among them, activated carbon having superior gas bubble adsorption capacity is preferably used.

However, if the content of the bubble-adsorbing particles having such an action as described above in the foaming composition is too high, there is a risk of deterioration of physical properties due to the occurrence of defects caused by the aggregation of the bubble-adsorbing particles and a rapid increase in temperature at the aggregated parts. If the content of the bubble-adsorbing particles is too low, the effect given by the use of the bubble-adsorbing particles is negligible. Thus, it is preferable that the bubble-adsorbing particles be included in an amount of 0.1 to 10 parts by weight relative to 100 parts by weight of the phenolic resin.

Next, Step 2 is a step of adding a curing accelerator to the foaming composition and then curing and expanding the foaming composition by irradiating the foaming composition with microwaves.

Regarding the curing accelerator, a sulfonic acid compound such as para-toluenesulfonic acid or xylenesulfonic acid can be used, and among these, one kind may be used alone, or a mixture of two or more kinds may be used.

In this case, if the amount of addition of the curing accelerator is too large, there is a risk that an unexpanded state may occur due to rapid curing at normal temperature. If the amount of addition of the curing accelerator is too small, there is a risk that curing may not proceed at the time of expansion by microwaves. Therefore, the curing accelerator is preferably added in an amount of 5 to 15 parts by weigh relative to 100 parts by weight of the phenolic resin.

Furthermore, a curing aid such as resorcinol, cresol, o-methylolphenol or p-methylolphenol can be further added together with the curing accelerator.

As a result of the addition of the curing accelerator, curing of the foaming composition begins at normal temperature, and this curing is achieved slowly in the beginning, while curing occurs relatively rapidly after a lapse of time. Here, the degree of curing occurring in the time period up to the time point of the occurrence of rapid curing is referred to as the “initial degree of curing”, and the initial degree of curing can be regulated by the aging time in which curing is achieved as the time passes at normal temperature after stirring.

In the present invention, the normal temperature curing cycle of a phenol-based expanded plastic was analyzed in order to determine the viscosity increase resulting from the addition of bubble-adsorbing particles and the optimum initial degree of curing and the optimum time difference before expansion. In this case, in order to measure the curing cycle, the movement of dipoles was measured using dielectrometry, and the expansion time of the phenolic resin was determined from the results. In order to investigate the temperature change along with the curing cycle, temperature was simultaneously measured using thermocouple wires.

The dissipation factor is a constant representing the movement of dipoles and ions, and the value of the dissipation factor rises up rapidly as curing begins, and falls down rapidly after reaching the maximum. This is because the movement of dipoles and ions becomes active as curing begins, and after reaching the maximum, the movement is restricted by the formation of crosslinking bonds between polymer chains. A phenolic foam was molded using microwaves within a time period before the curing start point (t_{cs}, d²D/dt²=0; D: dissipation factor, t: time) and after the curing start point obtained from the dissipation factor thus measured.

Specifically, microwaves are irradiated within a time period of the curing start point±10%. When microwaves are irradiated within the time period described above, a particle-reinforced cellular foam having the cell density and the cell wall thickness well controlled can be produced by restricting the movement of enlargement of the gas bubbles generated at the time of expansion, consequently suppressing the growth of cells, and causing small and uniform cells to be formed. More preferably, microwaves are irradiated within a time period of the curing start point±5%.

The wavelength of the microwaves used at the time of microwave irradiation is from 10 mm to 1 m, and the frequency is 300 MHz to 3 THz. It is preferable to set the output power of the microwave irradiation to 100 W to 2000 W, and the irradiation time to 0.2 to 5 minutes.

A particle-reinforced cellular foam having a uniform cell size and a high cell density can be produced by the production method such as described above, without the use of a blowing agent. Furthermore, since bubble-adsorbing particles are added and a time difference is applied, the cells produced at the time of expansion acquires a closed cell structure through the regulation of the degree of curing. Therefore, superior thermal and mechanical characteristics, and specifically, superior specific strength and thermal insulation performance, are manifested as compared with the cellular foams of the prior art.

Thus, according to another embodiment of the present invention, a particle-reinforced cellular foam produced by the production method described above is provided.

The particle-reinforced cellular foam has a closed cell structure.

Furthermore, the particle-reinforced cellular foam includes cells having a diameter of 50 μm to 400 μm, and has a density of 50 kg/m³ to 150 kg/m³.

Since the particle-reinforced cellular foam described above has a closed cell structure, the cellular foam exhibits improved flame retardancy together with excellent thermal and mechanical characteristics. As a result, the particle-reinforced cellular foam is useful as a thermally insulating material.

Thus, according to still another embodiment of the present invention, a thermally insulating material containing the particle-reinforced cellular foam is provided.

Hereinafter, Examples of the present invention will be described in detail so that those having ordinary skill in the art to which the present invention is pertained can easily carry out the invention. However, the present invention can be embodied in various different forms and is not intended to be limited to the Examples described herein.

### Comparative Example 1-1

10% by weight of para-toluenesulfonic acid as a curing accelerator was added to 90% by weight of a resol type phenolic resin, the mixture was stirred, and then the mixture was expanded by irradiating microwaves (wavelength: 60 mm, frequency: 2450 MHz, output power: 800 W) to the mixture at a time point of the curing start point—5%. Thus, a cellular foam (a) was produced. Rapid expansion occurred within a short time of less than 1 minute by the microwaves.

### Comparative Example 1-2

A cellular foam (b) was produced in the same manner as in Comparative Example 1-1, except that microwaves were irradiated at the curing point.

### Comparative Example 1-3

A cellular foam (c) was produced in the same manner as in Comparative Example 1-1, except that microwaves were irradiated at a time point of the curing start point+5%.

### Example 1-1

An foaming composition was produced by mixing 89.1% by weight of a resol type phenolic resin with 1% by weight of activated carbon (average particle size: 44 μm (325 mesh)), and then stirring the mixture using a stirrer for 30 minutes at a rate of 500 rpm. 9.9% by weight of para-toluenesulfonic acid was added as a curing accelerator to the foaming composition, the mixture was stirred, and then the foaming composition was expanded by irradiating microwaves (wavelength: 60 mm, frequency: 2450 MHz, and output power: 800 W) thereto at a time point of the curing start point—5%. Thus, a cellular foam (d) was produced. Rapid expansion occurred within a short time of less than 1 minute by the microwaves.

### Example 1-2

A cellular foam (e) was produced in the same manner as in Example 1-1, except that microwaves were irradiated at the curing point.

### Example 1-3

A cellular foam (f) was produced in the same manner as in Example 1-1, except that microwaves were irradiated at a time point of the curing start point+5%.

### Examples 2 to 4

Cellular foams were produced in the same manner as in Example 1-1, except that the amount of use of the activated carbon used in Example 1 was changed to 3% by weight, 5% by weight, and 7% by weight, respectively.

### Test Example 1

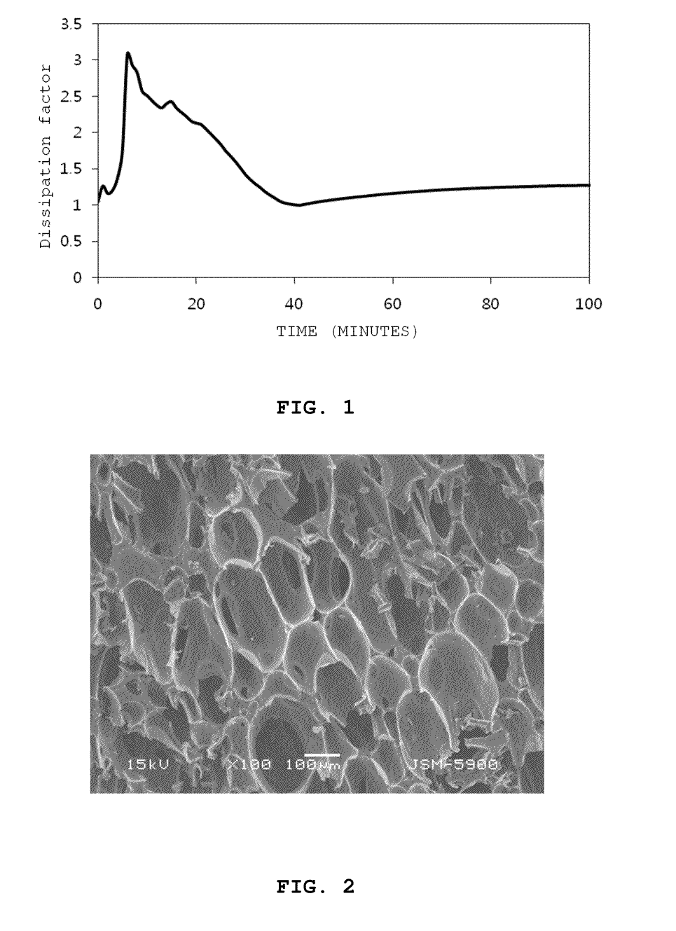

At the time of producing the cellular foam according to Example 1-1, the movement of dipoles was measured using a dielectric constant sensor, and at the same time, the extinction coefficient of the cellular foam was measured during the operation of normal temperature curing using thermocouple wires. Thus, the normal temperature curing cycle was analyzed from these data. The results are presented in FIG. 1.

The extinction coefficient means the movement of dipoles of a material, and the degree of curing of a resin can be inferred from this extinction coefficient. That is, as the extinction coefficient increases, the movement of dipoles becomes active, and thereby, the viscosity of the resin for forming a cellular foam is decreased. Accordingly, the maximum value of the extinction coefficient means the point at which the viscosity of the resin for forming a cellular foam reaches the minimum, and curing begins at the inflection point of a rapidly increasing region.

As shown in FIG. 1, the initial value of the extinction coefficient was rapidly increased at the time of producing the cellular foam according to Example 1-1, and the extinction coefficient reached a maximum value. Thereafter, the extinction coefficient exhibited a change of rapidly falling.

### Test Example 2

For the particle-reinforced cellular foam of Example 1-2 that was produced using microwaves at the curing start point, the form of the expanded cells and the cell walls were observed using a scanning electron microscope (SEM). The results are presented in FIG. 2.

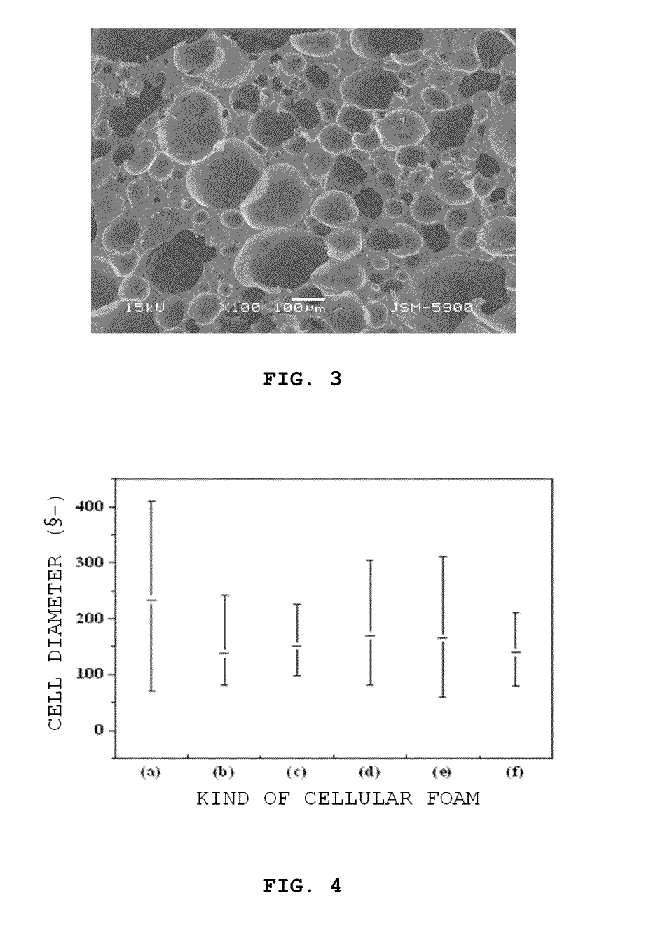

FIG. 2 is a photograph showing the SEM observation results of the particle-reinforced cellular foam (e) produced in Example 1-2, and FIG. 3 is a photograph showing the SEM observation results of the cellular foam (b) produced in Comparative Example 1-2.

As shown in FIG. 2 and FIG. 3, the particle-reinforced cellular foam (e) of Example 1-2 that was produced using microwaves at the curing start point, formed a closed cell structure composed of uniform cells and thin cell walls. On the other hand, it was confirmed that the cellular foam (b) of Comparative Example 1-2 to which no bubble-adsorbing particles were added, had a high percentage content of non-uniform cells and a solid formed as a result of failed expansion.

Furthermore, for the cellular foams produced in Examples 1-1 to 1-3 and Comparative Examples 1-1 to 1-3, the cell diameter and the density of the cellular foam were measured using a scanning electron microscope and a simple formula for calculating density. The results are presented in FIG. 4 and FIG. 5.

As shown in FIG. 4 and FIG. 5, the cellular foams (d to f) of Examples 1-1 to 1-3 contained smaller and uniform cells compared with the cellular foams (a to c) of Comparative Examples 1-1 to 1-3, and as a result, the cellular foams of the Examples exhibited higher cell densities. The results were obtained due to an increase in the resin viscosity caused by the addition of adsorbent particles, and adsorption of an internal gas to the adsorbent particles.

### Test Example 3

For the particle-reinforced cellular foams produced in Examples 1-1 to 1-3, the thermal conductivity was measured using a hot wire method.

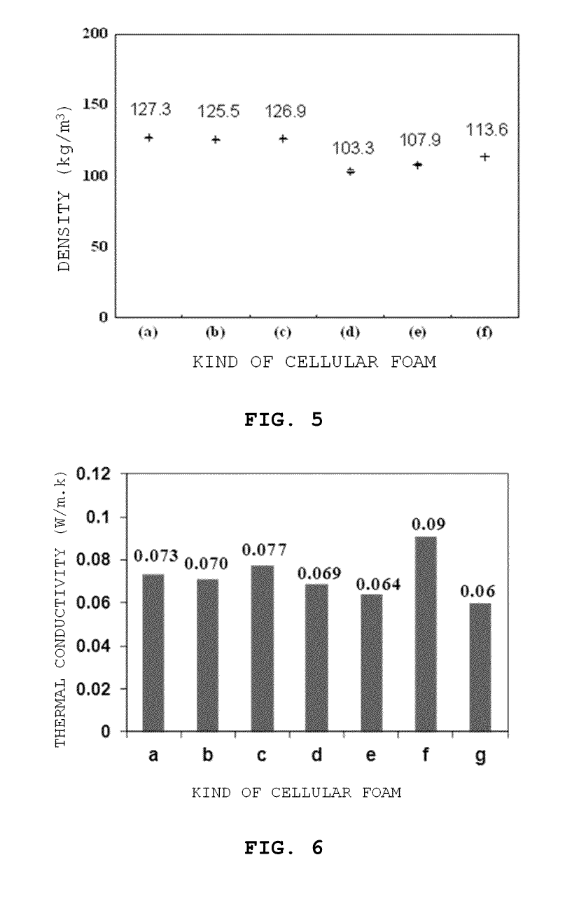

More specifically, a voltage was applied to a nichrome wire through a power supply according to DIN 51046. Subsequently, the temperature was measured using thermocouple wires, and the temperature change for a predetermined time was calculated. The thermal characteristics of the cellular foams were evaluated from those results. The results are presented in FIG. 6. At this time, a conventional polyurethane foam (g) was used for a comparison.

As shown in FIG. 6, the particle-reinforced cellular foams (d to f) of Examples 1-1 to 1-3 that were produced using microwaves, had their thermal conductivity decreased by 4.5% to 14.8% as compared with the cellular foams (a to c) of Comparative Examples 1-1 to 1-3 in which no adsorbent particles were added. Thus, it was confirmed that the thermal insulation properties were enhanced.

### Test Example 4

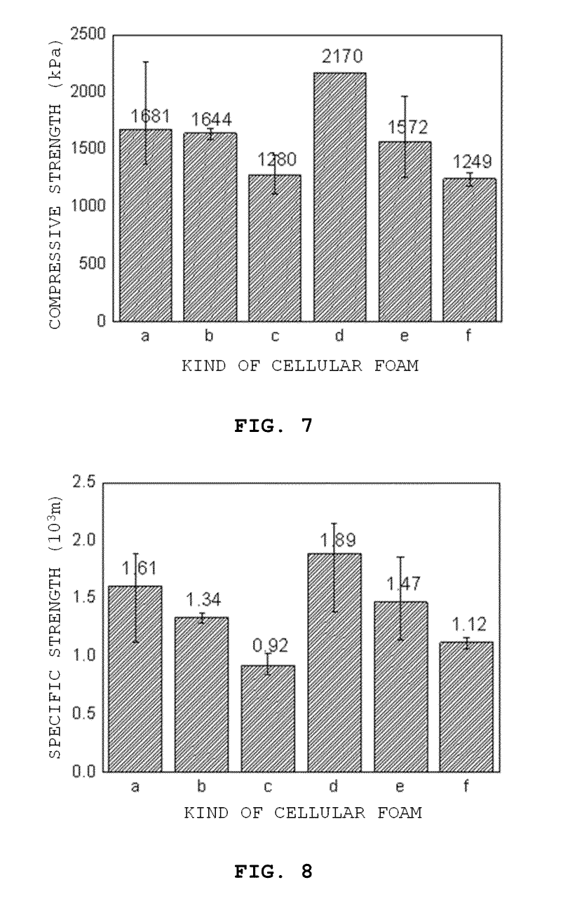

For the particle-reinforced cellular foams produced in Examples 1-1 to 1-3, the compressive strength and specific strength were measured according to ASTM C365 using a universal material testing machine (INSTRON), and the mechanical characteristics of the cellular foams were evaluated from those results. The results are presented in FIG. 7 and FIG. 8.

Furthermore, as shown in FIG. 7 and FIG. 8, the compressive strength and specific strength of the cellular foams produced using microwaves with time differences in the initial degree of curing were measured, and as a result, the particle-reinforced cellular foams (d to f) of Examples 1-1 to 1-3 exhibited compressive strength and specific strength that had increased by 7% to 15% as compared with the cellular foams (a to c) of Comparative Examples 1-1 to 1-3 that lacked the addition of particles. Thus, it was confirmed that the particle-reinforced cellular foams of the Examples had enhanced mechanical properties. Furthermore, it was confirmed that as the degree of curing increased, the compressive strength and the specific strength were gradually decreased. This is because of the stress shielding effects between thick walls and thin walls in a case in which the cellular foam is expanded after the curing start point, and as the time difference in the degree of curing increased, lower compressive strength and lower specific strength values were obtained.

As investigated in the above, the particle-reinforced cellular foams of Examples 1-1 to 1-3 formed uniform closed cells and thin cell walls, and it was demonstrated that the thermal and mechanical properties of the particle-reinforced cellular foams having such a closed cell structure were superior to the properties of conventional cellular foams.

### Test Example 5

For the particle-reinforced cellular foams produced in Examples 1-1 to 1-3, volatility based on temperature change was measured over a temperature range of 100° C. to 700° C. by a thermogravimetric analysis (TGA, Q600, manufactured by TA Instruments, Inc., USA), and thermal stability and safety were evaluated from the results. From these results, volatility at 100° C. is presented in the following Table 1.

TABLE 1

| | Kind of cellular | Volatility at |
|---|---|---|
| | foam | 100° C. (%) |
| Comparative | a | 2.47 |
| Example 1-1 | | |
| Comparative | b | 2.71 |
| Example 1-2 | | |
| Comparative | c | 1.9 |
| Example 1-3 | | |
| Example 1-1 | d | 1.96 |
| Example 1-2 | e | 2.21 |
| Example 1-3 | f | 1.91 |

As shown in the above Table 1, the cellular foams according to Examples 1-1 to 1-3 exhibited generally lower volatility compared with the corresponding cellular foams of Comparative Examples 1-1 to 1-3. From these results, it can be confirmed that the cellular foams according to Examples 1-1 to 1-3 exhibit higher thermal stability and safety during expansion, and that such an improving effect is induced from the activated carbon having a wide specific surface area, which was used during the production of the cellular foams.

Preferred embodiments of the present invention have been explained in detail; however, the scope of rights of the present invention is not intended to be limited to these embodiments. Various modifications and improvements may be made by those having ordinary skill in the art without departing from the spirit or scope of the general inventive concept as defined by the claims and their equivalents.

### INDUSTRIAL APPLICABILITY

According to the present invention, when micrometer-sized or nanometer-sized activated carbon particles are added at the time of producing an expanded foam, the activated particles adsorb gases produced during the operation of expansion, and thus the enlargement of cells by the gas bubbles and the generation of open cells can be suppressed. As a result, a closed cell structure having a uniform cell size can be formed. Therefore, a particle-reinforced cellular foam having markedly improved specific strength and thermal insulation performance as compared with conventional cellular foams can be produced, and this particle-reinforced cellular foam can be utilized in the thermally insulating materials for various applications such as construction decorations, automobiles, and liquefied natural gas (LNG) carrier vessels.

What is claimed is:

1. A method for producing a particle-reinforced cellular foam, the method comprising:
producing an foaming composition containing a phenolic resin and bubble-adsorbing particles; and
adding a curing accelerator to the foaming composition, and then irradiating microwaves to the foaming composition within a time period of the curing start point (t_{cs})±10%.

2. The method for producing a particle-reinforced cellular foam according to claim 1, wherein the phenolic resin is a resol type phenolic resin.

3. The method for producing a particle-reinforced cellular foam according to claim 1, wherein the bubble-adsorbing particles have an average particle size of 37 μm (400 mesh) to 595 μm (30 mesh).

4. The method for producing a particle-reinforced cellular foam according to claim 1, wherein the bubble-adsorbing particles are particles made of a material selected from the group consisting of activated carbon, activated alumina, zeolites, silica gel, molecular sieves, carbon black, and mixtures thereof.

5. The method for producing a particle-reinforced cellular foam according to claim 1, wherein the curing accelerator is a substance selected from the group consisting of para-toluenesulfonic acid, xylenesulfonic acid, and a mixture thereof.

6. The method for producing a particle-reinforced cellular foam according to claim 1, wherein the microwaves are irradiated within a time period of the curing start point±5%.

7. A particle-reinforced cellular foam produced by the method according to claim 1.

8. The particle-reinforced cellular foam according to claim 7, wherein the particle-reinforced cellular foam has a closed cell structure.

9. The particle-reinforced cellular foam according to claim 7, wherein the particle-reinforced cellular foam has a cell diameter of 50 μm to 400 μm and a density of 50 kg/m³ to 150 kg/m³.

10. A thermally insulating material, comprising a particle-reinforced cellular foam produced by the method according to claim 1.
